(19) United States
(12) Patent Application Publication
(10) Pub. No.: US 2009/0254424 A1
(43) Pub. Date: Oct. 8, 2009

(54) ENHANCED ONLINE ADVERTISING EXPERIENCE

(75) Inventor: Donald Swanson, Mountain View, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/061,285

(22) Filed: Apr. 2, 2008

(51) Int. Cl. G06Q 30/00; G06F 3/048; G06F 15/16

(52) U.S. Cl. 705/14; 715/767; 709/204

(57) ABSTRACT

A method for enhancing user advertising experience, the method including operatively integrating advertising content of an advertisement to be displayed on a web page with additional web content different from web content displayed on the web page; displaying an indicia in conjunction with the advertisement to indicate to a user that the advertisement includes a portal to the additional web content; sensing a browsing action by the user that engages the indicia; and altering the advertisement so that a space occupied by the advertisement displays the additional web content for viewing and engagement by the user.

### BACKGROUND

1. Technical Field

The disclosed embodiments relate to a system and methods for enhancing user advertising experience, and more specifically, to providing advanced features, including additional web content, delivered in conjunction with advertisements to benefit users, advertisers, and publishers.

2. Related Art

Internet advertising is a multi-billion dollar industry and is growing at double digits rates in recent years. It is also the major revenue source for internet companies, such as Yahoo!® or Google®, which provide advertising networks that connect advertisers, publishers, and Internet users. New and creative ways to attract users' attention to advertisements or to the sponsors of those advertisements help to grow the effectiveness of online advertising, and thus increases the growth of sponsored advertising. Publishers partner with advertisers, or allow advertisements to be delivered to their web pages, to help pay for the published content, or for other marketing reasons, and to synergistically develop their web space into a meaningful online market for users. Simultaneously, users desire information they seek and tools they find useful to be effectively delivered while not being overwhelmed with unwanted advertising or unnecessary browsing or searching.

### SUMMARY

By way of introduction, the embodiments described below are drawn to a system and methods for enhancing user advertising experience, and more specifically, to providing advanced features, including additional web content, delivered in conjunction with advertisements to benefit users, advertisers, and publishers.

In a first aspect, a method is disclosed for enhancing user advertising experience, the method including operatively integrating advertising content of an advertisement to be displayed on a web page with additional web content different from web content displayed on the web page; displaying an indicia in conjunction with the advertisement to indicate to a user that the advertisement includes a portal to the additional web content; sensing a browsing action by the user that engages the indicia; and altering the advertisement so that a space occupied by the advertisement displays the additional web content for viewing and engagement by the user.

In a second aspect, a method is disclosed for enhancing user advertising experience, the method including operatively integrating advertising content of an advertisement to be displayed on a web page with additional web content different from web content displayed on the web page; displaying an indicia in conjunction with the advertisement to indicate to a user that the advertisement includes a portal to the additional web content; automatically animating the indicia to draw attention to the additional web content; sensing a browsing action by the user that engages the indicia; and altering the advertisement so that the space occupied by the advertisement displays the additional web content for viewing and engagement by the user.

In a third aspect, a method is disclosed for enhancing user advertising experience, the method including sending a web page over a network to be displayed on a client device, the web page including an advertisement and an indicia to be displayed with the advertisement to indicate to a user of the client device that the advertisement includes a portal to additional web content different from web content displayed on the web page; receiving an indication from the client device that the user has engaged the indicia; and sending the additional web content to be displayed in an advertising space occupied by the advertisement in response to receiving the indication that the user has engaged the indicia.

In a fourth aspect, a server is disclosed for enhancing user advertising experience, including a memory to store instructions as executed. A database stores the instructions and sponsored web content. A processor is operable to execute the instructions and to access the sponsored web content, wherein the processor operatively integrates advertising content of an advertisement to be displayed on a web page with sponsored web content different from web content displayed on the web page; serves the integrated advertising and sponsored web content to the web page; displays an indicia in conjunction with the advertisement to indicate to a user that the advertisement includes a portal to the sponsored web content; senses a browsing action by the user that engages the indicia; and alters the advertisement so that a space occupied by the advertisement displays the sponsored web content for viewing and engagement by the user.

In a fifth aspect, a system is disclosed for enhancing user advertising experience including a processor operable to send a web page over a network to be displayed on a client device. The web page includes an advertisement and an indicia to be displayed with the advertisement to indicate to a user of the client device that the advertisement includes a portal to additional web content different from web content displayed on the web page. A receiver is operable to receive an indication from the client device that the user has engaged the indicia. A transmitter is operable to send the additional web content to be displayed in an advertising space occupied by the advertisement in response to receiving the indication that the user has engaged the indicia.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for enhancing user advertising experience bundling advertising content with features such as additional web content.

FIG. 2 is a screen shot displaying a web page with a portal and indicia to donated additional web content space, which underlies an advertisement.

FIG. 3 is a screen shot displaying the additional web content space underlying the advertisement of FIG. 2 after the indicia has been engaged.

FIG. 4 is a screen shot displaying an embodiment of a transition of the advertisement displayed in FIG. 2 when indicia associated therewith is engaged by a user.

FIG. 5 is a flow chart of an exemplary method for enhancing user advertising by bundling advertising content with features such as additional web content.

FIG. 6 is a flow chart of another embodiment of a method for enhancing user advertising by bundling advertising content with features such as additional web content.

FIG. 7 is a flow chart of another embodiment of a method for enhancing user advertising by delivering additional web content to a user device after receiving indication that a user has engaged an indicia.

### DETAILED DESCRIPTION

By way of introduction, the disclosed embodiments relate to a system for leveraging space on a web page reserved for advertising to display, at least part of the time and generally in response to a user engagement, additional web content that may be of use or interest to the user. Various forms of animation or signaling may be used in conjunction with an indicia in order to indicate to the user that presence or accessibility of such additional web content.

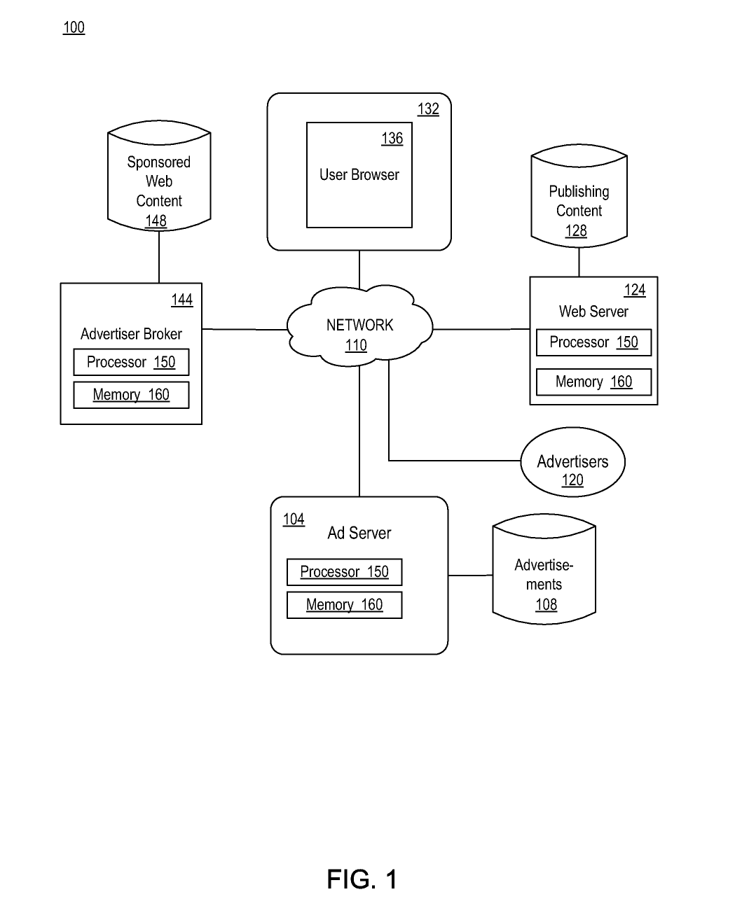

FIG. 1 is a diagram of an exemplary system 100 for enhancing user advertising experience bundling advertising content with features such as additional web content. The system 100 includes an ad server 104 having an advertisements database 108, a network 110, a plurality of advertisers 120, a web server 124 having a publishing content database 128, a plurality of user (or client) connection devices 132 having web browsers 136, and an advertiser broker server 144 having an additional content/feature database 148. The network 110 may include the internet or World Wide Web (“Web”), a wide area network (WAN), a local area network (“LAN”), and/or an extranet, connected to through use of either a wired or wireless connection.

The ad server 104, the web server 124, and the advertiser broker server 144 may each include a processor 150 and a memory 160 and other hardware that would be associated with a computer server. For instance, a computer server may include communications modules such as a receiver and a transmitter (not shown), and/or a transceiver (not shown), to communicate through the network 110 with other computers or machines, such as with the client connection devices 132.

An internet user, with the browser 136, may connect through any number of connection devices 132 such as a personal computer, a personal digital assistant (PDA), a cellular phone, a laptop, a mobile device capable of browsing or searching the internet, etc. The connection goes through the network 110 and pulls down web pages (e.g., publishing content) from the web server 124. Such publishers usually partner with any number of advertisers 120. An advertiser broker 144, such as Google of Mountain View, Calif. or Yahoo! of Sunnyvale, Calif., may be used as a go-between publishers (e.g., of the web server 124) and advertisers 120 to deliver ad content sponsored by the latter to web wages of the former. The ad server 104, which may be owned and operated by the advertiser broker 144, has ready access to advertisements paid for by the advertisers 120, and may store them locally or in a distributed manner in the advertisement database 108. When a user clicks on a link to a website from either a search results page or through a browsing action (including direct entry of a uniform resource locator (URL) in the browser 136), the website and affiliated web content are delivered to the browser 136 for viewing together with (hopefully relevant) advertisements from the database 108. Note that the advertiser brokers may also be considered publishers, and indeed, do publish much of their own content together with which advertisements may be served.

In addition to the advertisements available for delivery through the ad server 104, the advertiser broker server 144 may store additional web content/features in its database 148 that may be local or distributed as well. The database 148 for the additional web content/features may be the same as or in communication with the advertisement database 108 of the ad server 104. Accordingly, the ad server 104 may be combined with the advertiser broker server 144 as a single server. The advertiser broker or a third-party partner of the advertiser broker may supply advanced features or additional web content (together “additional web content”), which is different than the web content already delivered to a web page, to be bundled or integrated with these advertisements when delivered to the web page. The advertisement space used by this integrated web and advertising content is intended to be shared, but either one may include part of the space of a web page not common to the other.

Likewise, that the additional web content is bundled or integrated with advertising content does not imply that the additional web content has to be delivered to the Web browser 136 at the same time; to the contrary, the additional web content may be delivered or served separately after the web page is loaded with the advertisement and the original web content of that page. Note that the additional features or web content are delivered or served automatically with or after the advertising content of the advertisement, and therefore, the user need do nothing extra to access the additional web content, such as downloading a plug-in or toolbar, etc. The user need only engage the indicia, or in some cases, set up the system 100 such that the additional web content is automatically loaded and presented for viewing a predetermined period of time after the web page is loaded. The latter may be accomplished, for instance, through use of a pre-loaded plug-in or toolbar, etc.

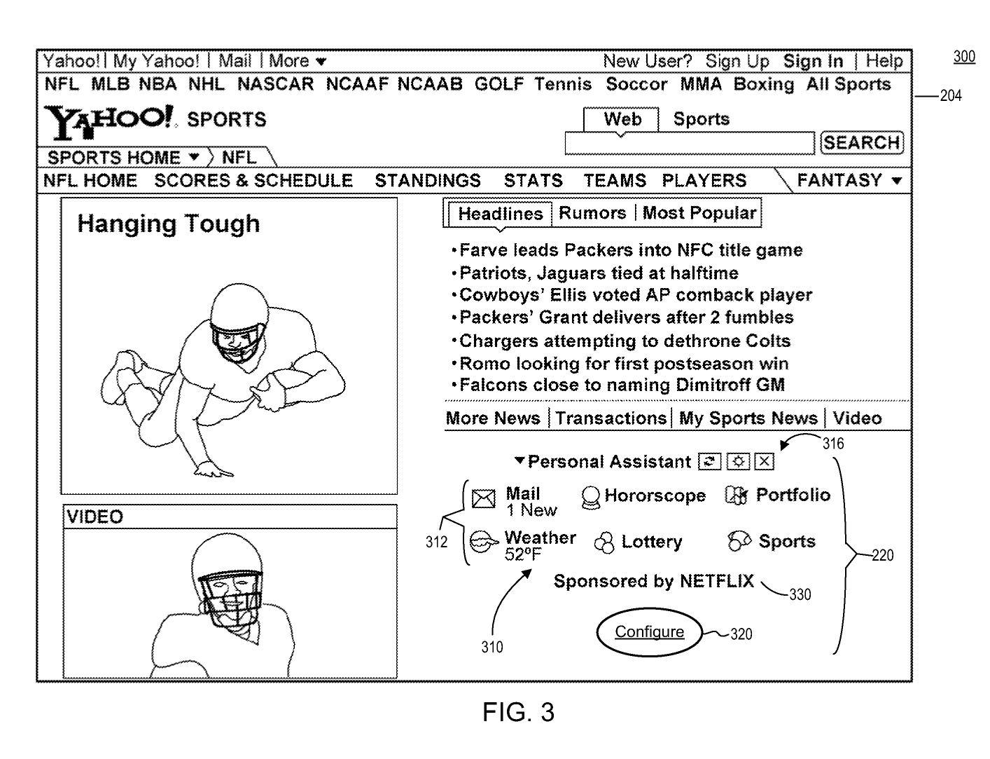

The additional web content may provide additional benefits to the users, the advertisers, and the publishers. That is, the additional web content may give users tools to interact with an advertising space to quickly access timely information specific to the user. As will be seen in FIG. 3, this space may include stock quotes, a mail inbox, an instant messaging portal, news headlines, local weather, a search box, etc. A user can treat an ad space position as a personal work-space to perform quick lookups or other tasks. The advertiser then sponsors the user's tasks (or workspace) by “donating” the space. The ad-view is nevertheless preserved, for example, by allowing the user to move the integrated advertisement to a new location, which may include elsewhere on the browser, to the desktop, or to another program. The publisher benefits by keeping the user on his or her web page while the user performs a simple task that the user need not browse away from the publisher's web page to perform. When the user is done with the task, the user may continue viewing the publisher's page. When a user clicks on the advertiser broker's (or third-party partner's) web links for increased exposure to the tools and content of the additional web content, the latter benefit from increased traffic.

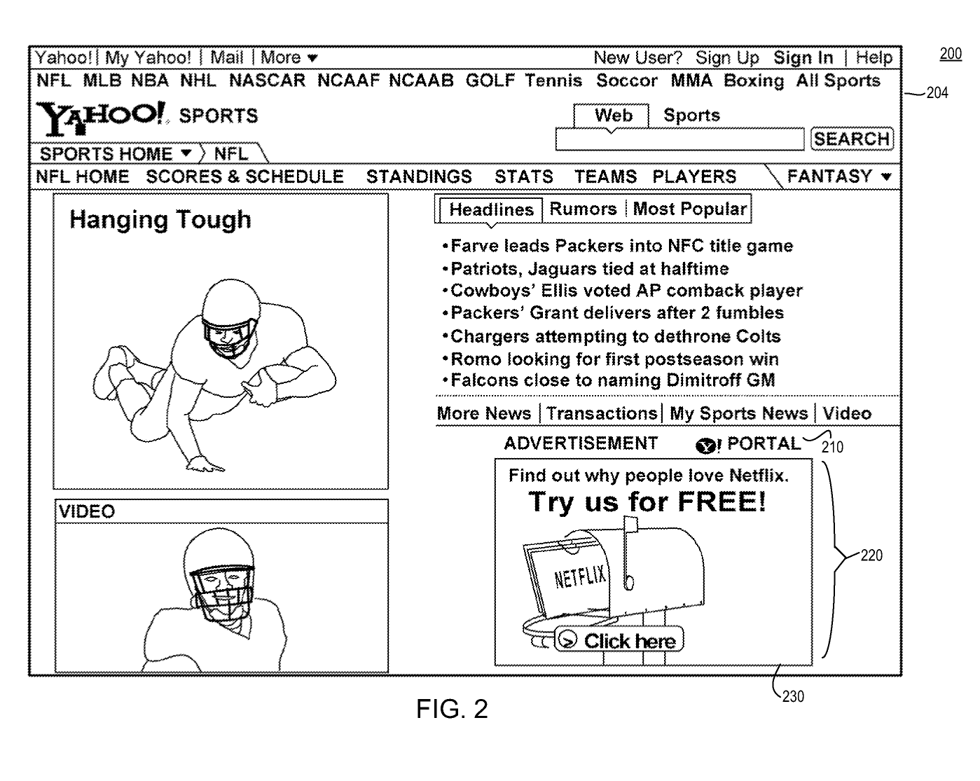

FIG. 2 is a screen shot 200 displaying a web page 204 with a portal and indicia 210 to donated additional web content space 220, which underlies an advertisement 230. A portal in this context makes reference to a virtual doorway or passageway to the additional web content referred to above. Note that this web page 204 is published by an advertising broker, but this need not be the case as it may be any web page to which the ad server 104 delivers advertisements and that is part of the system 100 of which the advertiser broker is a part. The advertisement 230 may include a hyperlink that when selected, directs the user's browser 136 to a web page of the advertiser sponsoring the advertisement 230.

The indicia 210 may be designed to attract the attention of users browsing the internet, and accordingly, may be animated in various ways to draw such attention. For instance, the indicia 210 may be made to blink, rotate, change shape, change color, pulsate, dissolve, shrink to nothing, bubble, evaporate, and/or move around or act in some way to draw attention. The indicia 210 may also read “click me for useful tools” or “click here for additional content” or some other descriptive term or phrase to grab the attention of browsing users.

As discussed in more detail below, when a user drags an input (such as a mouse cursor) over the indicia 210 or clicks on the indicia 210 to engage it, the advertisement 230 transitions to become movable or somehow disappears or fades away. What is exposed is additional web content (310 in FIG. 3). In lieu of use of the indicia 210, however, a third party plug-in, toolbar, or other executable program may be employed that provides a button (not shown) somewhere on the user browser 136 window. When an advertisement 230 shows up on a web page 204, the plug-in or toolbar may detect where the advertisement 230 is on the web page 204. Upon a user engaging the plug-in or toolbar button, the advertisement is removed just as it would be if the user engages the indicia 210, effectively circumventing the indicia with use of the plug-in or toolbar. In some cases, such a plug-in or toolbar may automatically dispense with the advertisement 230 when the user browsers to the web page 104, without needing to engage a button. The main difference with a plug-in (or toolbar) is that these would always be there and would work for any advertisement, whereas the indicia 210 is only affiliated with the advertisement 210 with which it is bundled or integrated, optionally at the permission of the advertiser.

FIG. 3 is a screen shot 300 displaying the additional web content space 220 underlying the advertisement of FIG. 2 after the indicia 210 has been engaged. Note that once the indicia 210 is engaged, the advertisement either disappears or becomes somehow removable to expose an additional web content 310. The additional web content 310 displayed in FIG. 3 includes a personal assistant, such as that provided by Yahoo! of Sunnyvale, Calif. The additional web content 310 (personal assistant) may include a number of links 312, such as to e-mail, weather, horoscope, lottery, portfolio, and sports. When clicked, these links may take the user to web page content normally delivered in relation to the subject matter of these links, either in a separate browser, tab, or in the additional web content space 220 itself.

The additional web content 310 may also include some action buttons 316, such as refresh, stop, and close to help the user interact with and use the tools or content provided therein. If the “close” option is selected, the additional web content 310 may be again concealed by the same or a different advertisement. Accordingly, a user may advantageously access and interact with the additional web content 310 much more quickly and conveniently than if the user had to open a new browser 136 or tab to make such access, and then track multiple browsers or tabs to continue accessing information. For instance, the user may want to track his or her stock quotes in real time through the additional web content 310 while catching up on various news items on the web page.

The additional web content 310 may be displayed with a button 320 that enables the user to configure the additional web content 310, e.g., from previous advertising experience, so that the user knows what content he or she will get when engaging the indicia 210 on or near subsequent advertisements on other web pages 204. Such configuration may require entering a username or password to login so that the additional web content 310 may connect directly to the desired content, such as the personal assistant displayed in FIG. 3. Additional content that may be configured includes a picture of a friend or pet that has been uploaded to a photo sharing site such as Flickr, or viewing of a slideshow from Flickr. If desired, the user may so configure the additional web content so that substantially the same additional web content is served each time the indicia 210 is engaged on other web pages made available by the advertiser broker server 144.

The indicia 210 may be engaged by dragging a mouse cursor over and/or selecting the indicia 210 with an input selector, such as with a mouse click, so that a piece of code associated with the indicia will be executed. This may be performed with Java script code, for instance. The action the code may take includes a number of different options. For instance, the indicia 210 may be fashioned as a bent corner of a page, engagement of which allows a user to peel the advertisement 230 back to expose the additional web content 310. Furthermore, engagement of the indicia 210 may also cause the advertisement to “pop-off” and float so that the user may click and drag the advertisement 230 to another place on a screen of the user's connection device 132, including into another location of the browser 136, into another compatible program, or to a desktop location. In the alternative, the advertisement 230 may be made to be transparent so that the additional web content 310 may be seen through it enough so that the user may adequately read and interact therewith.

All of these options will advantageously help the user engage positively with the advertisement knowing that he or she will be able to access additional utility or content of interest in the additional web content 31 0. The system 100 may also cause the advertisement, once engaged, to transition to a different advertisement or message to catch the moment of user engagement to again grab the user's attention. The additional message may include a discount or free offer, a link to an educational marketing script, or an animated advertisement, etc. In the alternative, a plug-in or other script may be employed by the system 100 to automatically engage the indicia 210, without user intervention, to dispose of the advertisement. The user may be allowed to configure the additional web content 310 to be automatically displayed upon browsing to a web page that displays the advertisement. After a predetermined amount of time, the indicia may be automatically engaged such that the advertisement is disposed of, revealing the additional web content 310.

A sponsored link (or indicia) or other secondary advertisement 330 may be included in the content space 220 together with the additional web content 310. In FIG. 3, a sponsored link 330 states “Sponsored by NETFLIX,” and allows the advertiser to remind the user who has donated the space they are using. The size and extent of this secondary advertisement 330 depends on the additional space remaining after display of the additional web content 310. Any secondary indicia or advertisement 330 may be displayed together with the same or different hyperlink associated with the original advertisement 230, engagement of which can redirect the user's browser 136 to a website of the advertiser.

Similar to an embodiment previously discussed, the advertisement 230 of FIG. 2 may be made transparent such that the underlying additional web content 310 of FIG. 3 is viewable through the advertisement 230 within the additional content space 220. In this additional embodiment, the indicia 210 may be the additional web content 310. Because the additional web content 310 is viewable, the indicia 210 may be linked to the underlying additional web content 310, which also may be animated as discussed above. When a user engages the additional web content 310 through the transparent advertisement 230, the advertisement 230 may transition to disappearing or becoming movable so that it may be moved by the user or so that it reappears elsewhere on the screen of the connection device 132. Note that the additional web content 310 may also be displayed intermittently through the advertisement 210, which is made transparent intermittently to show the additional web content 310 that is accessible through engaging some indicia 210.

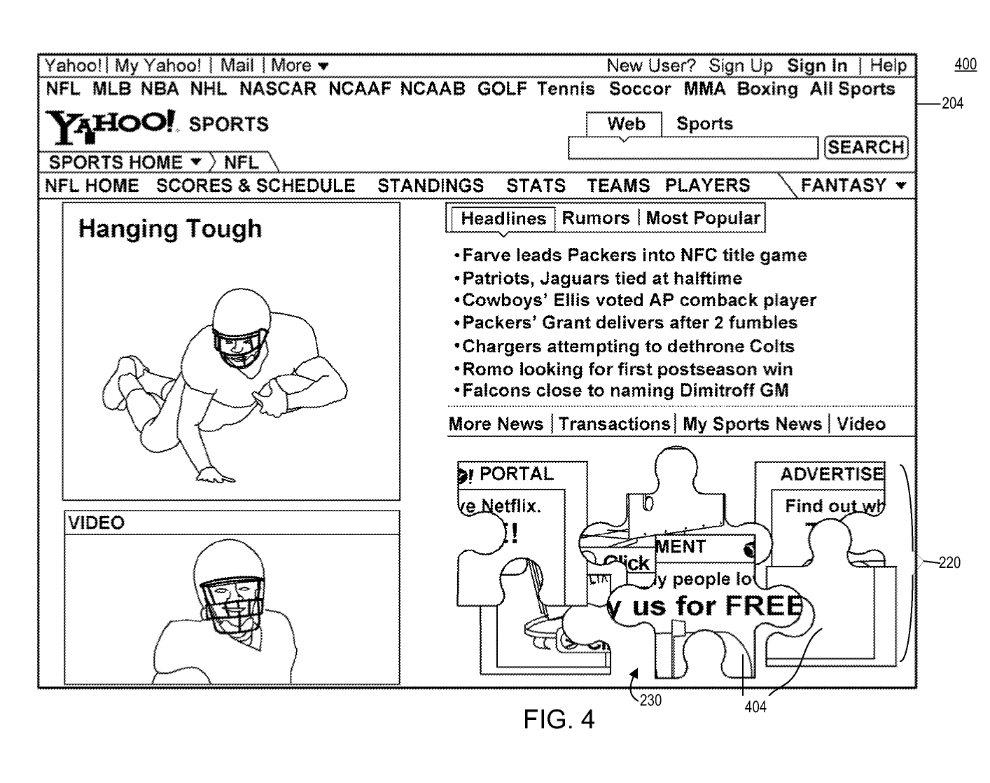

FIG. 4 is a screen shot 400 displaying an embodiment of a transition of the advertisement displayed in FIG. 2 when the indicia 210 associated therewith is engaged by a user. The embodiment show in FIG. 4 shows the advertisement broken into puzzle pieces 404. Accordingly, when the indicia 210 is engaged by the user, such as with an input device, the advertisement 230 becomes several puzzle pieces 404, which when assembled, causes it to “pop-off” and float, be shifted elsewhere automatically, or simply disappear. The advertisement 230 may also be peeled off. If the advertisement becomes movable by the user, the user may click and drag the advertisement 230 to another place on a screen of the user's connection device 132, including into another location of the browser 136, into another compatible program, or to a desktop location as discussed.

Likewise, in alternative embodiments, creative animation that use special effects may be used when transitioning from displaying the advertisement 230 to displaying the additional web content 310. For instance, the advertisement 230 could be animated for a set period of time. The indicia 210 (or additional web content 310, if the same) may also be animated, such as made to appear as an animal that walks up from a side of the browser 136 and devours the advertisement 230. The animal or animated indicia 210, as it approaches the advertisement 230, may be engaged by the user to cause the advertisement 230 to disintegrate by fire or the like. The advertisement 230 could also explode into several pieces over the browser 136 and/or the display screen of the connection device 132, and then fade away.

The transition may include a sound effect that is played during the transition as the advertisement 230 is disengaged or made to disappear. The volume level could be set by the user, with the default setting being silent. These transition effects could also be randomized so the user is encouraged to play with the advertisement 230 to see what happens. Numerous other ways of animating the indicia 210 and/or the advertisement 230 may be apparent to one of ordinary skill in the art such that users take interest in the advertisement 230 and the additional web content 310 accessible through engagement of the indicia 210.

Note that each page view of the web page on which the integrated advertisement 230 and additional web content 310 is served may include a different advertisement 230 to provide a variety of advertising to the user, in addition to extended ad exposure for the same or different advertisers. Additionally, part of the transition discussed above during which the advertisement 230 disappears or becomes movable, may include allowing the advertiser a small time window of approximately one to three seconds to display a special offer or an additional advertisement. The secondary advertisement 330 remaining in the additional web content space 220 may then be engaged by the user to access such special offer or advertiser's web page even after the advertisement 230 disappears or is relocated.

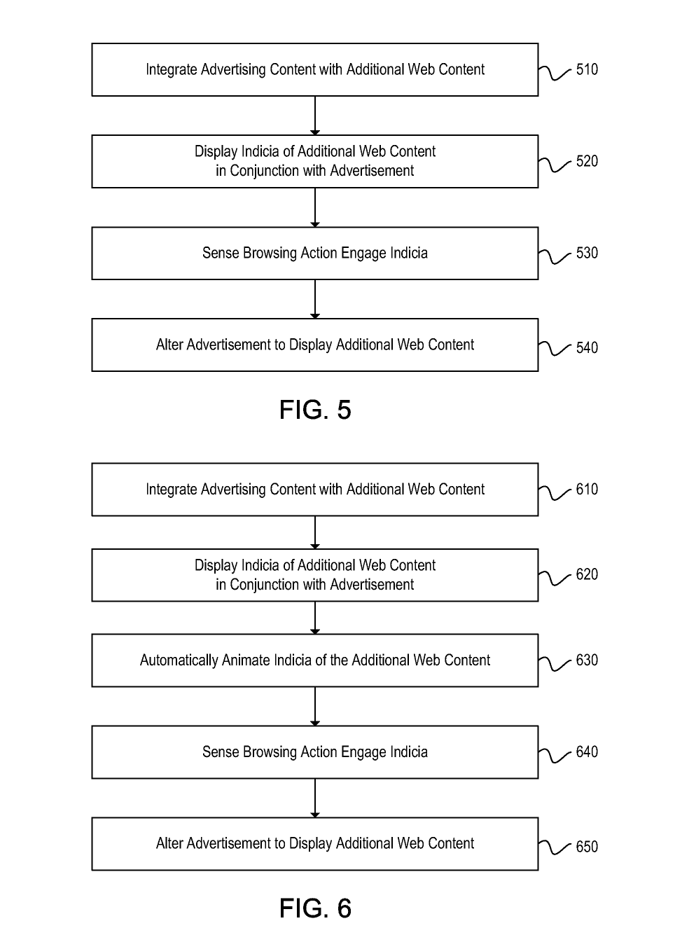

FIG. 5 is a flow chart of an exemplary method for enhancing user advertising by bundling advertising content with features such as additional web content. The method, at block 510, operatively integrates advertising content of an advertisement to be displayed on a web page with additional web content different from web content displayed on the web page. At block 520, it displays an indicia in conjunction with the advertisement to indicate to a user that the advertisement includes a portal to the additional web content. At block 530, it senses a browsing action by the user that engages the indicia. At block 540, it alters the advertisement so that a space occupied by the advertisement displays the additional web content for viewing and engagement by the user.

FIG. 6 is a flow chart of another embodiment of a method for enhancing user advertising by bundling advertising content with features such as additional web content. The method, at block 610, operatively integrates advertising content of an advertisement to be displayed on a web page with additional web content different from web content displayed on the web page. At block 620, it displays an indicia in conjunction with the advertisement to indicate to a user that the advertisement includes a portal to the additional web content. At block 630, it automatically animates the additional web content to draw attention to the additional web content. At block 640, it senses a browsing action by the user that engages the indicia. At block 650, it alters the advertisement so that the space occupied by the advertisement displays the additional web content for viewing and engagement by the user.

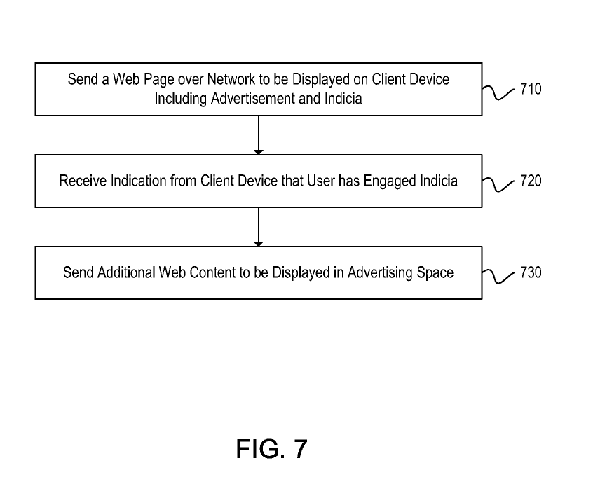

FIG. 7 is a flow chart of another embodiment of a method for enhancing user advertising by delivering additional web content to a user device after receiving indication that a user has engaged an indicia. The method, at block 710, sends a web page over a network to be displayed on a client device, the web page including an advertisement and an indicia to be displayed with the advertisement to indicate to a user of the client device that the advertisement includes a portal to additional web content different from web content displayed on the web page. At block 720, it receives an indication from the client device that the user has engaged the indicia. At block 730, it sends the additional web content to be displayed in an advertising space occupied by the advertisement in response to receiving the indication that the user has engaged the indicia. Note that the method may also pre-load the additional web content by sending the additional web content to the client device together with, or after, the web page is sent in anticipation of receiving the indication that the user has engaged the indicia. Furthermore, the method may sense a plug-in or script automatically engage the indicia, and send the additional web content to be displayed in an advertising space occupied by the advertisement in response to the engagement by the plug-in or script.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for enhancing user advertising experience, the method comprising:
operatively integrating advertising content of an advertisement to be displayed on a web page with additional web content different from web content displayed on the web page;
displaying an indicia in conjunction with the advertisement to indicate to a user that the advertisement includes a portal to the additional web content;
sensing a browsing action by the user that engages the indicia; and
altering the advertisement so that a space occupied by the advertisement displays the additional web content for viewing and engagement by the user.

2. The method of claim 1, wherein altering the advertisement comprises causing the advertisement to become transparent and form a background to the additional web content or to be lifted and moved to another location within a web browser or on a desktop of a computing device.

3. The method of claim 1, wherein altering the advertisement comprises making the advertisement movable and changing the content of the advertisement.

4. The method of claim 1, wherein altering the advertisement comprises causing the advertisement to disappear and to reappear in a second space of the web page.

5. The method of claim 1, wherein the additional web content comprises content of specific interest to the user, the method further comprising:
enabling the user to configure the type of additional web content to be displayed, wherein the configuration persists such that the user is served substantially the same additional web content each time an indicia on subsequent web pages is engaged.

6. The method of claim 5, further comprising:
requiring the user to login or register through a login screen located in the space to see the additional web content.

7. The method of claim 1, further comprising:
pre-loading the additional web content when the web page is loaded into a user web browser together with the advertisement, in anticipation of engagement of the indicia.

8. The method of claim 1, further comprising:
including in the space after the advertisement is altered a second indicia that displays at least the sponsor of the advertisement.

9. The method of claim 8, wherein the second indicia comprises a second advertisement by the sponsor selected from the group consisting of a special offer, a discount, and content related to the advertisement.

10. The method of claim 8, wherein the advertisement comprises a hyperlink to an advertiser web page, wherein the second indicia comprises a second advertisement by the sponsor, wherein the second advertisement also includes the hyperlink.

11. The method of claim 1, further comprising one of:
automatically engaging the indicia to disengage the advertisement so that the advertisement is not viewed by the user; and
enabling the user to download a plug-in or toolbar that circumvents the indicia to allow the user to cause the advertisement to disappear.

12. A method for enhancing user advertising experience, the method comprising:
operatively integrating advertising content of an advertisement to be displayed on a web page with additional web content different from web content displayed on the web page;
displaying an indicia in conjunction with the advertisement to indicate to a user that the advertisement includes a portal to the additional web content;
automatically animating the indicia to draw attention to the additional web content;
sensing a browsing action by the user that engages the indicia; and
altering the advertisement so that the space occupied by the advertisement displays the additional web content for viewing and engagement by the user.

13. The method of claim 12, wherein automatically animating the indicia comprises one or more of causing the indicia to blink, rotate, pulsate, change colors, move around, and be broken visually into a plurality of pieces.

14. The method of claim 12, wherein altering the advertisement comprises enabling the advertisement to be lifted and moved to another location within a web browser or on a desktop of a computing device.

15. The method of claim 12, wherein the additional web content comprises content of specific interest to the user, the method further comprising:
enabling the user to configure the type of additional web content to be displayed, wherein the configuration persists such that the user is served substantially the same additional web content each time an indicia on subsequent web pages is engaged.

16. The method of claim 15, further comprising:
requiring the user to register or login through a login screen located in the space to see the additional web content.

17. The method of claim 12, wherein in a transition between sensing the browsing action and altering the advertisement, the method further comprising:
displaying a special offer, discount, or additional advertising content to the user to attract interest of the user in the subject matter of the advertisement.

18. A server for enhancing user advertising experience, comprising:
a memory to store instructions as executed;
a database to store the instructions and sponsored web content;
a processor operable to execute the instructions and to access the sponsored web content, wherein the processor:
operatively integrates advertising content of an advertisement to be displayed on a web page with sponsored web content different from web content displayed on the web page;
serves the integrated advertising and sponsored web content to the web page;
displays an indicia in conjunction with the advertisement to indicate to a user that the advertisement includes a portal to the sponsored web content;
senses a browsing action by the user that engages the indicia; and
alters the advertisement so that a space occupied by the advertisement displays the sponsored web content for viewing and engagement by the user.

19. The server of claim 18, wherein upon user engagement of the indicia, the processor transitions the advertisement through a special effects transition before disappearing.

20. The server of claim 18, wherein the processor is operable to:
automatically animate the indicia to draw attention to the portal that leads to the sponsored web content; and
enable the advertisement, upon engagement of the indicia, to be lifted and moved to another location within a web browser or on a desktop of a computing device.

21. The server of claim 18, wherein the sponsored web content comprises content of specific interest to the user and a configure button, wherein the processor is operable to:
require the user to register or login through a login screen located in the space to see the sponsored web content; and
enable the user to configure the type of sponsored web content to be displayed, wherein the configuration persists such that the user is served substantially the same additional web content each time an indicia on subsequent web pages is engaged.

22. The server of claim 18, wherein the processor is operable to one of:
automatically engage the indicia to disengage the advertisement so that the advertisement is not viewed by the user a predetermined period of time after accessing the web page; and
enable the user to download a plug-in or toolbar that circumvents the indicia to allow the user to cause the advertisement to disappear.

23. The server of claim 18, wherein the processor is operable to:
insert in the space after the advertisement is altered a second indicia that displays at least the sponsor of the advertisement.

24. The server of claim 23, wherein the second indicia comprises a second advertisement by the sponsor selected from the group consisting of a special offer, a discount, and content related to the advertisement.

25. The server of claim 23, wherein the advertisement comprises a hyperlink to an advertiser web page, wherein the second indicia comprises a second advertisement by the sponsor, wherein the second advertisement also includes the hyperlink.

26. A method for enhancing user advertising experience, the method comprising:
sending a web page over a network to be displayed on a client device, the web page including an advertisement and an indicia to be displayed with the advertisement to indicate to a user of the client device that the advertisement includes a portal to additional web content different from web content displayed on the web page;
receiving an indication from the client device that the user has engaged the indicia; and
sending the additional web content to be displayed in an advertising space occupied by the advertisement in response to receiving the indication that the user has engaged the indicia.

27. The method of claim 26, further comprising:
animating the indicia that is sent with the advertisement to aid in drawing the attention of the user.

28. The method of claim 26, further comprising:
pre-loading the additional web content by sending the additional web content to the client device together with, or after, the web page is sent in anticipation of receiving the indication that the user has engaged the indicia.

29. The method of claim 26, further comprising:
sensing a plug-in or script automatically engage the indicia; and
sending the additional web content to be displayed in an advertising space occupied by the advertisement in response to the engagement by the plug-in or script.

30. A system for enhancing user advertising experience, comprising:
a processor operable to send a web page over a network to be displayed on a client device, the web page including an advertisement and an indicia to be displayed with the advertisement to indicate to a user of the client device that the advertisement includes a portal to additional web content different from web content displayed on the web page;
a receiver operable to receive an indication from the client device that the user has engaged the indicia; and
a transmitter operable to send the additional web content to be displayed in an advertising space occupied by the advertisement in response to receiving the indication that the user has engaged the indicia.

31. The system of claim 30, wherein the additional web content comprises content of specific interest to the user and a configure button, and wherein the processor is operable to:
enable the user to configure the type of additional web content to be displayed, wherein the configuration persists such that the processor sends to the user substantially the same additional web content each time an indicia on subsequent web pages is engaged.

32. The system of claim 31, wherein the processor is operable to:
require the user to register or login through a login screen located in the space to see the additional web content.

33. The system of claim 30, wherein the processor is operable to:
sense a plug-in or script automatically engage the indicia; and
send the additional web content to be displayed in an advertising space occupied by the advertisement in response to the engagement by the plug-in or script.
